(19) United States
(12) Patent Application Publication
(10) Pub. No.: US 2026/0230313 A1
(43) Pub. Date: Aug. 6, 2026

(54) A SYSTEM FOR CRYPTOGRAPHIC AGILITY WITH PROXY TASK MANAGEMENT

(71) Applicant: QUSECURE, INC., PETALUMA, CA (US)

(72) Inventors: Joseph Anythony Lupo, St. Louis, MO (US); Christopher Cap, Bayville, NJ (US); Scott Kawaguchi, San Jose, CA (US); Philip Gerald Vaccaro, Knoxville, TN (US); Steven L. Sexton, Delray Beach, FL (US)

(73) Assignee: QUSECURE, INC., PETALUMA, CA (US)

(21) Appl. No.: 19/159,740

(22) PCT Filed: Jan. 8, 2024
(86) PCT No.: PCT/US2024/010628

§ 371 Date: Aug. 26, 2025

Related U.S. Application Data
(60) Provisional application No. 63/502,365, filed on May 15, 2023.

(51) Int. Cl. H04L 9/08; G06F 7/58; H04L 9/14

(52) U.S. Cl. CPC H04L 9/0852; G06F 7/588; H04L 9/083; H04L 9/14; H04L 2209/76

(57) ABSTRACT

A method of cryptographic agility for post-quantum cryptography by swapping a ciphersuite is provided. The method can include performing, by a configuration agent or proxy, cryptography based on a current ciphersuite. The method can further include receiving, by the configuration agent and from a configuration orchestrator, instructions to invoke a protocol to swap the current ciphersuite. The method can further include invoking, by the configuration agent, the protocol to swap the current ciphersuite. The method can further include communicating, by a quantum secure layer (QSL) agent, a next ciphersuite from a set of ciphersuites to a key distribution center (KDC). The next ciphersuite can comprise a post-quantum ciphersuite, such as a next asymmetric or symmetric algorithm, cryptographic random number generator, or cryptographic hash function. The method can further include replacing the current ciphersuite with the next ciphersuite and performing cryptography based on the next ciphersuite.

### CROSS-REFERENCE TO RELATED APPLICATIONS

This application claims the benefit of priority of U.S. Provisional Application No. 63/502,365, titled “A System for Cryptography Agility with Proxy Task Management” and filed on May 15, 2023.

### BACKGROUND OF THE INVENTION

The development of non-classical computers, such as quantum computers, may pose a threat to existing encryption algorithms. There is a need for improved security systems that may be more resilient to non-classical computers.

### SUMMARY OF THE INVENTION

In an aspect, the present disclosure provides a method of cryptographic agility for post-quantum cryptography by swapping a ciphersuite. The method can include performing, by a configuration agent of a control plane or a proxy of a data plane, cryptography based on a current ciphersuite. The current ciphersuite can comprise one or more current asymmetric algorithm, one or more current symmetric algorithm, one or more current cryptographic random number generator, or one or more current cryptographic hash function. The method can further include receiving, by the configuration agent and from a configuration orchestrator, instructions to invoke a protocol to swap the current ciphersuite. The method can further include invoking, by the configuration agent and responsive to receiving the instructions, the protocol to swap the current ciphersuite. The method can further include communicating, by a quantum secure layer (QSL) agent, a next ciphersuite from a set of ciphersuites to a key distribution center (KDC). The next ciphersuite can comprise one or more next asymmetric algorithm, one or more next symmetric algorithm, one or more next cryptographic random number generator, or one or more next cryptographic hash function. The method can further include replacing the current ciphersuite with the next ciphersuite. The method can further include performing, by the configuration agent or the proxy, cryptography based on the next ciphersuite.

In some embodiments, the next ciphersuite can include at least one of, but is not limited to: Bit flipping Key Encapsulation Mechanism (BIKE); CRYSTALS Kyber; Classic McEliece; Hamming Quasi Cyclic (HQC); a National Institute of Standards and Technology (NIST) candidate post-quantum algorithm; Enhanced McEliece; Random Linear Code Encryption Scheme (RLCE); another next post-quantum algorithm; a hash deterministic random bit generator (Hash_DRBG); a hash-based message authentication code (HMAC_DRBG); SHA256; or AES256-GCM.

In some embodiments, performing the cryptography based on the next ciphersuite comprises performing the cryptography based on the next ciphersuite during a first session; and performing the cryptography based on the next ciphersuite during a subsequent session without renegotiating the next ciphersuite.

In some embodiments, performing the cryptography based on the next ciphersuite comprises performing at least one Key Encapsulation Mechanism (KEM) key exchange operation according to the next ciphersuite.

In some embodiments, the method further comprises performing a QSL authentication handshake or an external client flow according to the next ciphersuite.

In some embodiments, the method further comprises communicating, by the configuration agent and to the QSL agent, the next ciphersuite.

In some embodiments, replacing the current ciphersuite with the next ciphersuite comprises updating, by the QSL agent, a QSL agent ciphersuite based on the next ciphersuite.

In some embodiments, the next ciphersuite can comprise the one or more next asymmetric algorithm. The one or more next asymmetric algorithm can comprise one or more next Key Encapsulation Mechanism (KEM) algorithm.

In some embodiments, the one or more next KEM algorithm can comprise at least one of: a next static KEM algorithm to be used in a QSL authentication handshake; a next ephemeral KEM algorithm to be used in a QSL authentication handshake; or a next ephemeral KEM algorithm to be used in an external client flow.

In some embodiments, the one or more next KEM algorithm can comprise an ephemeral KEM algorithm. The cryptography based on the next ciphersuite can be performed by the proxy of the data plane. The method can further comprise receiving, by the proxy and from an external client, a request for the ephemeral KEM algorithm. The method can further comprise receiving, by the proxy and from the KDC, a parameter defining the ephemeral KEM algorithm. The method can further comprise forwarding, by the proxy and to the external client, the parameter.

In some embodiments, the next ciphersuite can comprise the next symmetric algorithm. The next symmetric algorithm can comprise a next Authenticated Encryption with Associated Data (AEAD) algorithm.

In some embodiments, the next ciphersuite can comprise the next cryptographic random number generator.

In some embodiments, the next cryptographic random number generator can comprise a next hash deterministic random bit generator (Hash_DRBG), a next hash-based message authentication code (HMAC_DRBG), or another next cryptographic random number generator.

In some embodiments, the next ciphersuite can comprise the next cryptographic hash function.

In some embodiments, the protocol to swap the ciphersuite can be performed by at least one of: the configuration agent; the configuration orchestrator; the control plane; a QSL agent; the KDC; or another tasking or control component.

In some embodiments, invoking the protocol to swap the ciphersuite comprises sending, by a QSL agent and to the KDC, a timestamp and a nonce (e.g., having a random or pseudorandom value). The method can further comprise tracking, by the KDC, a previous timestamp of a previous request of the configuration agent to swap the ciphersuite. Responsive to the timestamp not preceding the previous timestamp, the method can further comprise performing the protocol to swap the ciphersuite. The method can further comprise replacing the previous timestamp with the timestamp. The method can further comprise updating the nonce. The method can further comprise sending a response including the updated nonce.

In some embodiments, updating the nonce can comprise incrementing the nonce.

In some embodiments, the protocol to swap the ciphersuite can comprise a protocol to swap a server ciphersuite or a protocol to swap an external client ciphersuite.

In some embodiments, the method can further comprise receiving, by the configuration orchestrator, instructions from a user interface, a dashboard, a configuration management platform, or an automation platform.

In some embodiments, the cryptography based on the next ciphersuite can be performed by the proxy of the data plane. The proxy can comprise a reverse proxy or a forward proxy.

In some embodiments, the cryptography based on the next ciphersuite can be performed by the proxy of the data plane. The proxy can communicate with at least one of: a virtual machine; middleware; an application service; or a database.

In some embodiments, replacing the current ciphersuite with the next ciphersuite can comprise generating, by the QSL agent, a static Key Encapsulation Mechanism (KEM) keypair.

In another aspect, the present disclosure provides a computing system configured to provide cryptographic agility for post-quantum cryptography by swapping a ciphersuite. The computing system can comprise a memory and at least one processor coupled to the memory and configured to perform, via a configuration agent of a control plane or a proxy of a data plane, cryptography based on a current ciphersuite. The current ciphersuite can comprise one or more current asymmetric algorithm, one or more current symmetric algorithm, one or more current cryptographic random number generator, or one or more current cryptographic hash function. The processor can be further configured to receive, via the configuration agent and from a configuration orchestrator, instructions to invoke a protocol to swap the current ciphersuite. The processor can be further configured to invoke, via the configuration agent and responsive to receiving the instructions, the protocol to swap the current ciphersuite. The processor can be further configured to communicate, via a quantum secure layer (QSL) agent, a next ciphersuite algorithm from a set of ciphersuites to a key distribution center (KDC), wherein the next ciphersuite comprises one or more next asymmetric algorithm, one or more next symmetric algorithm, one or more next cryptographic random number generator, or one or more next cryptographic hash function. The processor can be further configured to replace the current ciphersuite with the next ciphersuite. The processor can be further configured to perform, via the configuration agent or the proxy, cryptography based on the next ciphersuite.

In another aspect, the present disclosure provides a non-transitory computer readable medium storing executable sequences of instructions for cryptographic agility for post-quantum cryptography by swapping a ciphersuite. The executable sequences of instructions can comprise instructions to perform, via a configuration agent of a control plane or a proxy of a data plane, cryptography based on a current ciphersuite. The current ciphersuite can comprise one or more current asymmetric algorithm, one or more current symmetric algorithm, one or more current cryptographic random number generator, or one or more current cryptographic hash function. The executable sequences of instructions can further comprise instructions to receive, via the configuration agent and from a configuration orchestrator, instructions to invoke a protocol to swap the current ciphersuite. The executable sequences of instructions can further comprise instructions to invoke, via the configuration agent and responsive to receiving the instructions, the protocol to swap the current ciphersuite. The executable sequences of instructions can further comprise instructions to communicate, via a quantum secure layer (QSL) agent, a next ciphersuite algorithm from a set of ciphersuites to a key distribution center (KDC), wherein the next ciphersuite comprises one or more next asymmetric algorithm, one or more next symmetric algorithm, one or more next cryptographic random number generator, or one or more next cryptographic hash function. The executable sequences of instructions can further comprise instructions to replace the current ciphersuite with the next ciphersuite. The executable sequences of instructions can further comprise instructions to perform, by the configuration agent or the proxy, cryptography based on the next ciphersuite.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a block diagram illustrating cryptography management in an organization's internal network.

FIG. 2 is a block diagram illustrating a system for cryptography management in an organization's network, according to an embodiment of the present disclosure.

FIG. 3 is a block diagram illustrating details of service-to-service communications among nodes of an organizational network, according to an embodiment of the present disclosure.

FIG. 4 is a block diagram illustrating an example network deployment with cryptographically agile post-quantum cryptography, which provides an expedient interface for managing cryptographic policy at scale, according to an embodiment of the present disclosure.

FIG. 5 is a block diagram illustrating details of a system for cryptographic agility by swapping a ciphersuite, according to an embodiment of the present disclosure.

FIG. 6A is a flow diagram illustrating a method of cryptographic agility by invoking a protocol to swap a ciphersuite, according to an embodiment of the present disclosure.

FIG. 6B is a flow diagram illustrating a method of quantum secure layer (QSL) authentication with cryptographic agility, according to an embodiment of the present disclosure.

FIG. 6C is a flow diagram illustrating a method of configuring external clients for cryptographic agility, according to an embodiment of the present disclosure.

FIG. 7 is a communication flow diagram illustrating a protocol to swap a ciphersuite, according to an embodiment of the present disclosure.

FIG. 8A is a flow diagram illustrating a method of cryptographic agility by swapping a ciphersuite, according to an embodiment of the present disclosure.

FIG. 8B is a flow diagram illustrating timestamp and nonce details of a server method of cryptographic agility by swapping a ciphersuite, according to an embodiment of the present disclosure.

FIG. 8C is a flow diagram illustrating timestamp and nonce details of a client method of cryptographic agility by swapping a ciphersuite, according to an embodiment of the present disclosure.

FIG. 9 is a block diagram of an example computer system which can perform any one or more of the methods described herein, in accordance with one or more aspects of the present disclosure.

### DETAILED DESCRIPTION

The invention will now be described more fully hereinafter with reference to the accompanying drawings, in which illustrative embodiments of the invention are shown. While various embodiments of the invention are shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” “less than or equal to,” or “at most” precedes the first numerical value in a series of two or more numerical values, the term “no more than,” “less than,” “less than or equal to,” or “at most” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, like characters refer to like elements.

Quantum computing technology currently under development may pose a threat to existing encryption algorithms, for example quantum computers may soon be able to break classical cryptographic algorithms. In particular, using a quantum computer, an attacker could potentially break into a private network and defeat classical cryptographic protections in order to compromise stored data, such as user data, sensitive data stored in secure computer systems, and the like. Accordingly, improved security systems have been developed, and continue to be developed, that are more resilient to non-classical computers such as quantum computers. For example, the National Institute of Standards and Technology (NIST) post-quantum encryption competition candidate algorithms are resilient against such quantum computing attacks. In order to improve adoption and portability of such post-quantum cryptographic methods, it is desirable to be able to swap cryptographic algorithm primitives implementing the NIST candidate post-quantum cryptographic methods expeditiously and in an orchestrated way, for example via a centralized orchestration node. For example, it is desirable to be able to rapidly swap an asymmetric cryptographic primitive, such as a key encapsulation mechanism (KEM), and/or a symmetric cryptographic primitive, such as an AEAD algorithm. The disclosed system and methods can address these demands.

In particular, the ability of a cryptographic protocol, application, or service to upgrade or swap out vulnerable cryptography with minimal disruption may be referred to as cryptographic agility. Cryptographic agility is sometimes subdivided into algorithm agility, which refers to swapping out a vulnerable algorithm (e.g., a weak symmetric cipher such as RC4 or an insecure hash function such as MD5) with minimal disruption for a stronger algorithm (e.g., AES or SHA-2); protocol agility, which refers to upgrading from a vulnerable protocol version (e.g., from TLS 1.0 to TLS 1.3); and implementation agility, which refers to quickly patching vulnerable algorithm implementations. The disclosed system and methods can implement rapid, deterministic, centrally orchestrated cryptographic agility, while improving administrative visibility over the cipher suites (e.g., including ciphers and hash functions; also referred to herein as ciphersuites) used throughout a network, and resisting downgrade attacks.

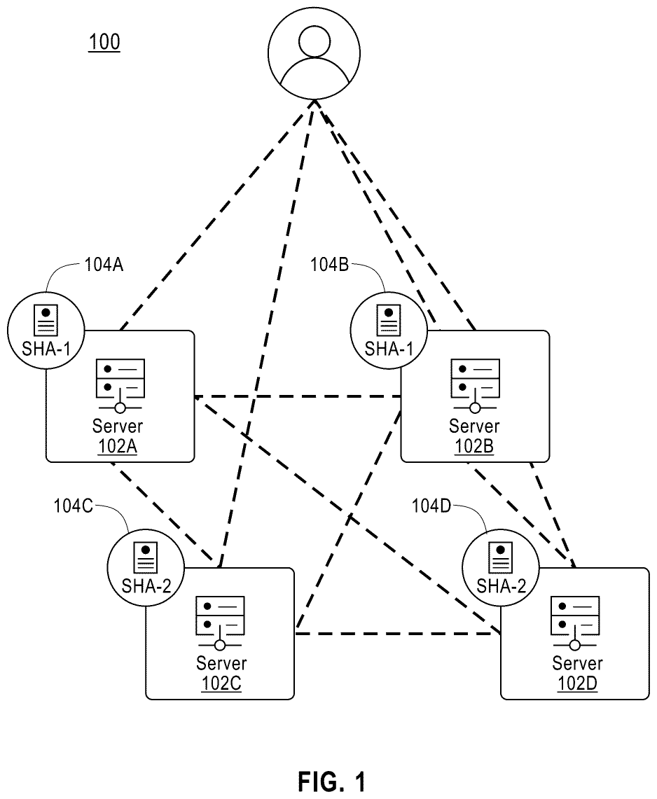

FIG. 1 is a block diagram 100 illustrating cryptography management in an organization's internal network, for example a local-area or other organizational network. The system 100 can include networked servers 102A-102D. The servers 102A-102D can include physical or virtualized network devices within network 100, such as switches and routers, which are responsible for forwarding data packets through a network. For example, the servers 102A-102D may include various enterprise resources or applications, such as a database, web application, file server, and the like, which may be nodes within an organizational network or local-area network. For example, in the case of a cloud-native microservice deployment, the system 100 could include many (e.g., several hundred) such servers 102A-102D.

As shown, the servers 102A-102D can perform cryptography with cipher suites (also referred to herein as ciphersuites) or algorithms, such as ciphersuites 104A-104D, respectively. For example, ciphersuites 104A-104D may include ciphers, key exchange algorithms, bulk encryption algorithms, message authentication code (MAC) algorithms, and/or hash functions. In this example, ciphersuites 104A-104B are SHA-1, while ciphersuites 104C-104D are SHA-2. In some examples, the servers 102A-102D can perform post-quantum or quantum-resilient cryptography, for example using the NIST post-quantum candidate algorithms. This enables the system 100 to defend against quantum computing attacks. However, the system 100 can face challenges with upgrading or swapping out vulnerable or obsolete ciphersuites (e.g., insufficient cryptographic agility), because cryptography-related tasks such as setting up and managing an enterprise PKI or configuring IPsec peers may be complex, time-intensive, error-prone, and highly decentralized. Moreover, such tasks may require knowledge of library-, application-, or vendor-specific configurations in order to deploy properly.

In the example of FIG. 1, if an administrator wishes to know which ciphersuite or algorithm is used between two nodes, for example between servers 102B and 102C, it may be necessary for the administrator to inspect the path exchanged between those two nodes. In addition, the system 100 may provide an ad hoc approach to swapping ciphersuites such as KEMs, for instance by requiring ciphersuite switching to be manually implemented by the administrator.

For example, if the servers 102A-102D communicate via a legacy Transport Layer Security (TLS) protocol, each session may begin with a TLS handshake, which includes a negotiation phase, among all the involved nodes. During this negotiation, a client may announce or present a listing of the ciphersuite protocols it supports. When setting a ciphersuite, a respective client and server may engage in a negotiation phase. For instance, the server may obtain a listing of ciphersuites that the server supports, as well as a listing of ciphersuites that the client prefers, and then choose among these ciphersuites. While the outcome of such a negotiation process may be predictable based on the two listings, crucially, the resulting ciphersuite may not necessarily match the administrator's first choice. For example, the administrator may wish to utilize the BIKE algorithm, yet BIKE may be unavailable on some nodes, and therefore may not be selected in the negotiation. Accordingly, such a negotiation phase may reduce the administrator's control over the outcome (referred to herein as determinism), while also increasing the process' complexity. For example, the negotiation phase may provide an implicitly deterministic outcome, in that if a given client only support a single ciphersuite, then the negotiation outcome can be deterministically expected to be the supported ciphersuite. However, the negotiation phase may not provide an explicitly deterministic outcome, in that if the client supports multiple ciphersuites, the administrator's control over the outcome may be lost. In addition, the negotiation phase may provide an attack surface for a malicious actor to potentially commit a downgrade attack, which would weaken the algorithm below the optimal outcome from negotiation.

In addition, swapping ciphersuites may raise logistical (e.g., orchestration) challenges, which may become overwhelming if an ad-hoc approach to cryptographic agility is employed within network 100. For example, to eliminate all SHA-1 TLS certificates in use in the network 100 (e.g., in order to upgrade SHA-1 to SHA256 or another SHA-2 algorithm) could require an administrator or IT team to identify all SHA-1 certificates on every endpoint 102A-102D, either manually or using individually-configured scripts or discovery tools. Furthermore, cryptographic procedures may be strongly coupled to particular applications. For example, the procedures to configure TLS for an Apache web server with mod SSL, for Redis, or for MongoDB may all differ from each other, and from those to deploy Nginx with TLS. Even if higher-level aspects of these different cases are similar, such fragmentation can complicate or slow upgrade processes for IT teams, especially if network 100 contains significantly many nodes 102A-102D. Consequently, the system 100 may suffer from impaired agility and longer deprecation periods (i.e., the period from a demonstration of vulnerability in an algorithm, protocol, or implementation, until the patching or upgrading of all vulnerable applications and services). For example, for TLS, deprecation periods for vulnerable algorithms and protocol versions have at times lasted years. During such long deprecation periods, data in transit within network 100 may be more vulnerable to being compromised.

Another challenge for cryptographic agility is that it may be inseparable from the negotiation phase of a secure channel protocol. For instance, a ciphersuite negotiation phase is included in both TLS and the Internet Key Exchange (IKE), an important component of IPsec. As in the case of cryptographic agility, for protocol agility the two parties may likewise settle on a mutually supported protocol version within the same negotiation phase. However, such an approach to agility may be subject to flaws. First, negotiation may necessitate additional round trips, which can add latency and bandwidth to each handshake. Second, negotiation may add complexity to a protocol. Complexity, in turn, can make security more difficult to analyze and can introduce vulnerabilities, especially in the case of a network adversary that is able to freely drop, inject, or modify protocol messages. For example, downgrade attacks are a type of attack in which an active network adversary (e.g., a man-in-the-middle (MITM)) attacks a protocol negotiation phase such that the subsequent secure channel or key exchange suffers from weakened or absent encryption. Many types of downgrade attacks exist to vulnerable ciphersuites or protocol versions.

Protocols that use a negotiation phase may also lack visibility over cryptographic details. Visibility refers to knowledge of the cryptography in use, and how it corresponds to the data being protected. For example, for a given channel used to transmit data of a certain sensitivity level, visibility can include knowledge of the cryptographic libraries, algorithms, or key sizes used in secure connections, the frequency of key rotation, where keys are stored, and how randomness is generated. This information may be dispersed across endpoints in configuration files or logs. For protocols with a negotiation phase, there may be poor visibility over the algorithms actually used for each connection.

Accordingly, there is a need to swap cryptographic algorithm primitives implementing post-quantum cryptographic methods expeditiously, in an orchestrated way, and with improved visibility. For example, there is a need to rapidly swap an asymmetric cryptographic primitive, such as a KEM, and/or a symmetric cryptographic primitive, such as an AEAD algorithm. The system and methods disclosed herein below can address these needs.

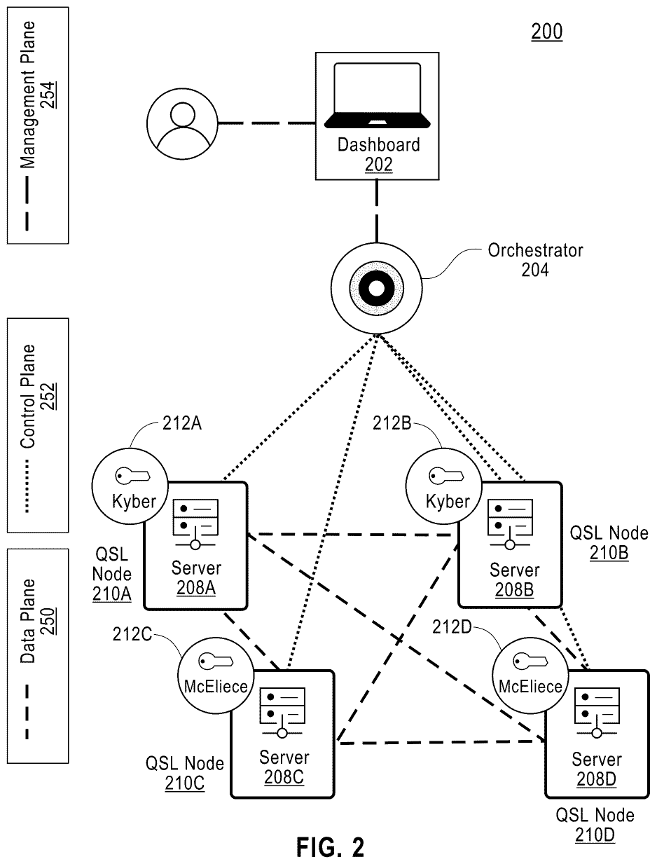

FIG. 2 is a block diagram illustrating a system 200 for orchestrated cryptography management in an organization's network (e.g., a local-area or other organizational network), according to an embodiment of the present disclosure. Unlike system 100 of FIG. 1, the system 200 is designed to provide centrally orchestrated cryptographic agility.

The system 200 can include a networked set of quantum secure layer (QSL) nodes 208A-208D, which may also be referred to as endpoints or servers, and are analogous to the servers 102A-102D of the example of FIG. 1. As in the example of FIG. 1, the servers 208A-208D within network 200 can include physical or virtualized network devices, such as switches and routers, which are responsible for forwarding data packets through a network. The servers 208A-208D can include physical or virtualized network devices within network 200, such as switches and routers, different enterprise resources or applications, such as databases, web applications, file servers, and the like. For example, in the case of a cloud-native microservice deployment, the system 200 could include many such nodes 208A-208D.

Unlike in FIG. 1, in this example, the various components can be conceptually organized into a data plane 250, control plane 252, and management plane 254, as described further below. This organization abstracts the operational details of cryptographic agility, so that an administrator can direct cryptographic agility at the level of policy from management plane 254, while the control plane 252 implements that policy, and the data plane 250 actually encrypts network traffic.

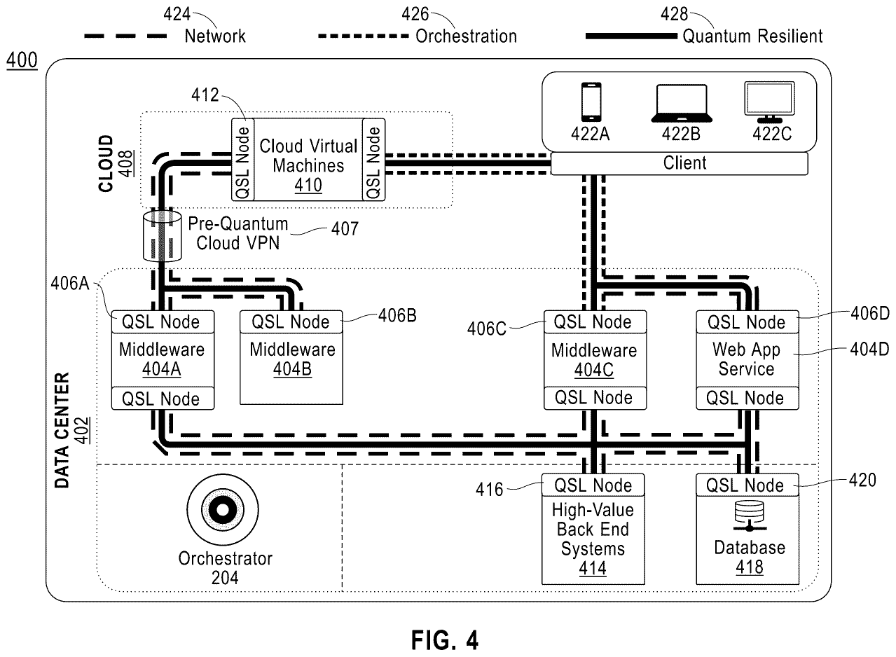

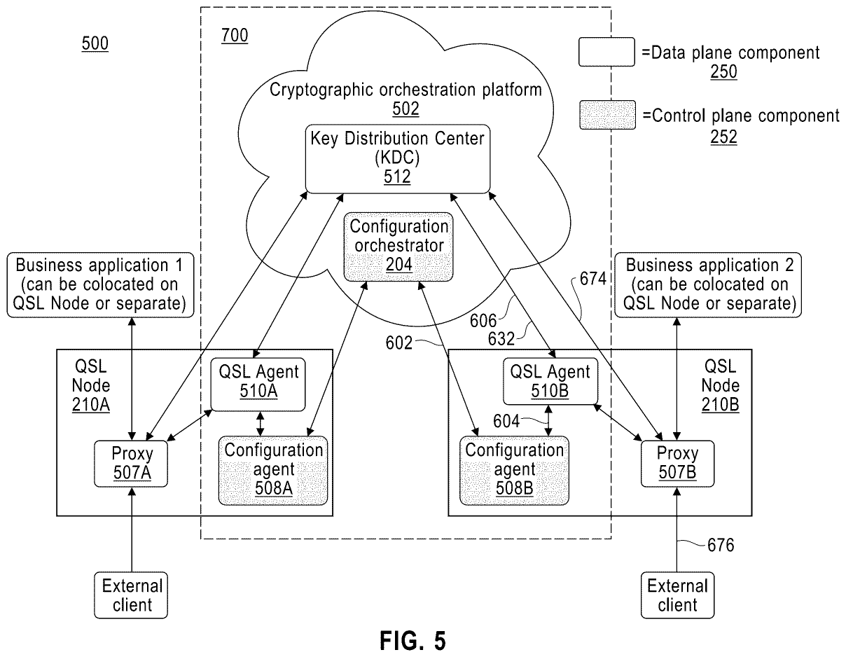

In addition, in this example, each of servers 208A-208D can include a corresponding QSL node 210A-210D, which can implement cryptography according to a ciphersuite 212A-212D. For example, the ciphersuites 212A-212D may include ciphers, key exchange algorithms, bulk encryption algorithms, MAC algorithms, and/or hash functions. For example, QSL node 210A can implement cryptography according to a Kyber ciphersuite 212A, QSL node 210B can implement a Kyber ciphersuite 212B, QSL node 210C can implement cryptography according to a McEliece ciphersuite 212C, and QSL node 210D can implement cryptography according to a McEliece ciphersuite 212D. In some examples, each of QSL nodes 210A-210D can include a respective proxy, which may implement the cryptography according to the corresponding ciphersuite of ciphersuites 212A-212D, and can be an important QSL component, as described in the examples of FIGS. 4-5 below.

Furthermore, unlike system 100 of FIG. 1, system 200 can include a centralized management interface 202 (also referred to as a dashboard), as well as an orchestrator computing node 204. Management interface 202 and orchestrator 204 can provide an administrator with platforms for orchestrating and centrally administering cryptography performed by the components of system 200 at the level of policy. For example, orchestration may include centralization and administration. For example, using the dashboard or management interface 202, the administrator can register new endpoints and manage the algorithms used by those endpoints. In another example, the administrator can use the orchestrator 204 to orchestrate and centrally administer aspects of cryptographic agility, such as swapping cryptographic primitives, as disclosed herein. In addition, the management interface 202, and/or the orchestrator 204, can provide a single dashboard view (also referred to as a single pane of glass) for an administrator to interact with at the level of cryptographic policy, while concealing lower-level implementation details. For instance, dashboard or management interface 202 may include a user interface (UI) that can expose which cryptographic algorithm is being used by each endpoint at any time.

As disclosed herein, the system 200 can provide multiple advantages over a more ad hoc approach to swapping ciphersuites, such as the approach of the system 100 of FIG. 1. For example, system 200 provides advantages such as deterministic cryptographic agility, improved visibility, resistance to downgrade attacks, and improved speed and expedience (e.g., central orchestration).

Cryptographic agility is a critical first advantage provided by the system 200. In particular, the disclosed system and methods can change the ciphersuites used by all nodes of network 200, including changing the keys. For example, if new cryptanalysis were to degrade the security of Kyber512 to an unacceptable level, the administrator could respond by easily upgrading all channels of system 200 using Kyber512 to a stronger ciphersuite, such as Kyber768 or Kyber1024, via the dashboard 202 or orchestrator 204. Similarly, in the unlikely situation that Kyber algorithms in general were compromised, the administrator could promptly swap all channels using Kyber to another ciphersuite, such as BIKE, HQC, or Classic McEliece. Likewise, the system 200 can expeditiously upgrade a symmetric algorithm, such as SHA-1 (as shown in the example of FIG. 1), to a more secure symmetric algorithm, such as SHA256 or another SHA-2 algorithm. Accordingly, the system 200 can improve the manual or ad-hoc methods to change ciphersuites used with system 100 of FIG. 1 by streamlining or even fully automating them.

In addition, using system 200, such cryptographic agility can be deterministic. By contrast with system 100, system 200 can enable the administrator to deterministically choose the next ciphersuite to be used throughout the system. For example, the administrator can choose a next ciphersuite, such as BIKE, via the dashboard 202 or orchestrator 204, and can be certain that the system 200 will be able to swap from the current ciphersuite to the chosen next ciphersuite. As disclosed herein below, when the administrator makes such a choice, the orchestrator 204 can instruct a configuration agent to invoke a protocol to swap the ciphersuite, the configuration agent can invoke the protocol to swap the ciphersuite, and a QSL agent and/or a proxy (e.g., belonging to a QSL node, as in the example of FIG. 5 below) can execute the protocol. Subsequently, the next invocation of a QSL Authenticate protocol can utilize the next ciphersuite selected by the administrator. Accordingly, the system 200 can begin to perform cryptography based on the next ciphersuite set by the administrator, as a deterministic outcome of the administrator's instructions via dashboard 202 or orchestrator 204.

Another advantage provided by system 200 is improved visibility. For example, the system 200 can represent the ciphersuite used by each endpoint or communication channel within the network 200 at all times, for example by displaying or outputting this information via the UI of management interface 202. This significantly improves the system's auditability, for instance by supplying the administrator with details of the cryptographic algorithms used by each endpoint, which may greatly simplify auditing and compliance tasks for IT teams. In addition, the visual dashboard 202 can provide a high-level overview of successful and failed connections throughout the network 200. Failed connections within network 200 can thereby be detected and pinpointed, providing additional insight for IT and security teams.

Still another advantage provided by system 200 is resistance to downgrade attacks, such as those described in the example of FIG. 1. Recall that when performing TLS between servers 102A-102D in the system 100 of FIG. 1, each session would start with a handshake including a negotiation, wherein the client would announce the ciphersuite protocols it supports, and the server would then choose among them. By contrast, the system 200 can avoid such in-protocol negotiation, rather setting the next ciphersuite deterministically, as discussed above.

In particular, the orchestrator 204 can configure algorithms and key sizes for the servers 208A-208D and/or QSL nodes 210A-210D, which encrypt data and execute secure channel protocols. To accomplish this, the system 200 can use a configuration protocol for endpoints 208A-208D, which can execute over an independent post-quantum secure channel (e.g., initiated via PQNoise). Because agility can be implemented centrally (e.g., by orchestrator 204), any potential downgrade attack would require compromising this independent configuration channel, therefore requiring a secondary attack beyond the downgrade attacker threat model. Moreover, even if an adversary succeeded in compromising the configuration channel, such a malicious reconfiguration could be detected and investigated as an auditable event by a security team.

In some examples, the system 200 can support a rich cryptographic policy interface via the management plane, such as: pushing updates to endpoints 208A-208D for implementation agility, implementing key rotation and management policies, and setting the source of entropy for keys. Instead of negotiation, each party can execute the protocol with respect to a ciphersuite (e.g., configured by orchestrator 204) including a static KEM algorithm, an ephemeral KEM algorithm, an AEAD (symmetric encryption) algorithm, and a cryptographic hash function. Considered from a high level, the static KEM can provide a longer-term key pair to be used for authentication. Note that using a KEM for authentication offers practical advantages over a post-quantum digital signature scheme. At the same time, the ephemeral KEM can provide forward secrecy to all connections. This property means that a future compromise of the static KEM private key has no implications on the security of past communications.

Note also that the PQNoise specification permits the use of two different KEMs as the static KEM and ephemeral KEM. Importantly, the system 200 can exploit this feature by using different static and ephemeral KEMs, which have substantially different security properties (e.g., depend on different security assumptions). This choice provides redundancy, safeguarding past data even in the case that future cryptanalysis should break or weaken either of the two KEMs, thus avoiding a single point of failure. In one example, the system may use an algorithm profile such as the code-based Classic-McEliece as static KEM and the lattice-based Kyber as ephemeral KEM.

Accordingly, by setting ciphersuites deterministically and executing the protocol with respect to such a fixed configuration, system 200 can avoid negotiation overhead and clarify security considerations. In some examples, the ciphersuite configuration may be fixed or persist across multiple sessions. For example, message formats can be unambiguous, message sizes can be deterministic, and the protocol state machine can be a straight line. Further, the system 200 can resist downgrade attacks, and security guarantees can be straightforwardly analyzed, limiting the need for protocol agility.

A final advantage provided by system 200 is that vulnerable cryptography can be swapped out substantially faster than with the ad-hoc approaches of system 100. For example, the disclosed system and methods for centrally-orchestrated cryptographic agility may reduce the deprecation period associated with vulnerable algorithms from months or years, instead upgrading or replacing vulnerable algorithms in just minutes. Thus, system 200 can provide effective cryptographic agility in effectively real time.

The various components of system 200 can belong to various planes, including a data plane 250, control plane 252, or management plane 254, by analogy with the planes in software-defined networking (SDN). In particular, the arrangement of components of system 200 into these planes abstracts details of cryptographic agility, so that an administrator can direct cryptographic agility at the level of policy.

The data plane 250 can encrypt traffic in network 200. For example, data plane 250 can include the servers 208A-208D, e.g. physical or virtualized network devices, such as switches and routers, which are responsible for forwarding data packets through a network.

The control plane 252 can enforce a given cryptographic policy from the management layer (e.g., from management plane 254), and/or can expose an interface to management plane 254 to manage the cryptography used to secure communications between endpoints 208A-208D. The primary component of the control plane 252 may be the high-availability, centralized orchestrator node 204.

The management plane 254 enables an administrator to direct cryptographic agility at the level of policy. It can include a user-facing dashboard 202 and the orchestrator 204. In some examples, the dashboard 202 can be executed by orchestrator 204. Within dashboard 202, administrators can register new endpoints and manage the algorithms used by those endpoints. In particular, the system 200 can support algorithmic agility via dashboard 202. For example, if new cryptanalysis degrades the security of Kyber512 to an unacceptable level, then an administrator can use dashboard 202 to upgrade all channels currently using Kyber512 to Kyber768 or Kyber1024 with the click of a button. Similarly, if Kyber were hypothetically discovered to be totally broken, then administrators could immediately switch all channels using Kyber to BIKE, HQC, or Classic-McEliece.

Thus, the system 200 can function at the level of cryptographic policy, while concealing lower-level implementation details from administrators. In some examples, system 200 may extend this principle to support policies relating to key rotation times, libraries, and entropy sources for all communications within a protected network.

Applying an analogy to cryptography, the components of data plane 250 can be considered as the secure channel protocols and the entities executing those protocols. In some cases, data plane 250 may be referred to as the Quantum Secure Layer (QSL). In some examples, the data plane 250 can include various elements, such as a protocol framework, a KDC, QSL nodes, QSL agents, proxies, and other post-quantum elements, as disclosed herein below (e.g., in the example of FIG. 5).

To upgrade a network to post-quantum, a post-quantum secure channel protocol should be developed or leveraged. To this end, a protocol framework that uses post-quantum KEMs (e.g, the PQNoise Protocol Framework described by Y. Angel et al., Proc. 2022 ACM SIGSAC Conference on Computer and Communications Security, p. 97, 2022) may be deployed as the basis for creating post-quantum secure channels. In some examples, the system can follow practices of the protocol framework, for example by omitting any in-band negotiation of ciphersuite or protocol version within a QSL protocol handshake.

In some examples, the system can include other components, as described below in the example of FIG. 5. For example, the system can employ a high-availability and scalable key distribution center (KDC) to support centralized generation of high-entropy keys, QSL agents, or configuration agents, and/or may communicate with external clients.

The system 200 can include a QSL solution which can transparently upgrade a web application to post-quantum with no code changes or client-side installs, as described further in the example of FIG. 4 below. From a cryptography perspective, the system may execute an ephemeral KEM exchange over HTTPS with a browser-based service worker, which proxies web application requests. As part of the protocol, the KDC can generate and distribute a high-entropy session secret to both the browser agent and the proxy (e.g., service worker). Each party then derives AEAD (symmetric) session keys from the session secret for encrypting subsequent communications. Note that “quantum-resilient” or “post-quantum” may include resilience and/or security against active classical adversaries who will have access to a cryptographically-relevant quantum computer (CRQC) in the future. In particular, such an adversary models the “store now, decrypt later” attack, which can pose an immediate threat to sensitive data. “Quantum-resilient” or “post-quantum” may also include resilience and/or security against adversaries with active or current access to a CRQC.

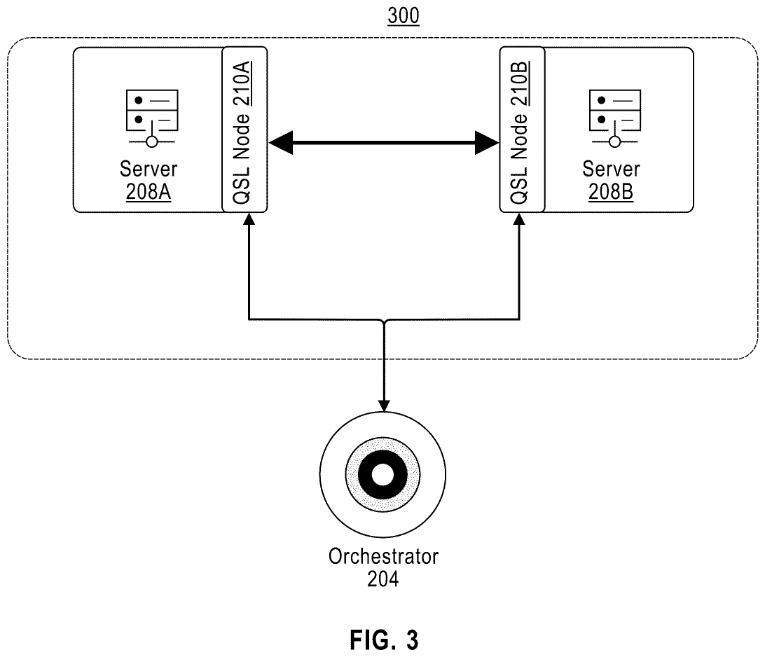

Likewise, as described further in the example of FIG. 3 below, the system 200 can also include a QSL solution designed to transparently upgrade service-to-service communications at layer 4 or layer 7 to post-quantum with no code changes. System 200 can achieve this goal by providing proxies before network applications 210A-210D to apply uniform encryption, authentication, and authorization, as described below. For example, such proxies may execute on QSL nodes 210A-210D and/or be associated with QSL nodes 210A-210D. The system can establish mutual authentication between a pair of proxies and securely distribute a session secret. Each party can then derive AEAD session keys for encrypting subsequent communications.

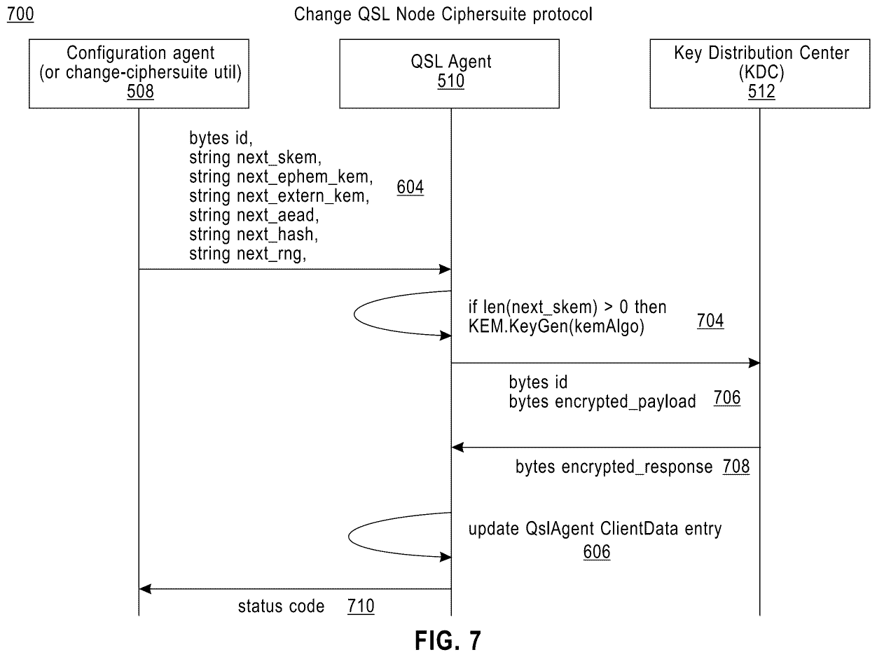

As described herein, both the QSL agent and KDC can have a fixed set of algorithms with which they can execute PQNoise secure channel protocols or execute flows of quantum-secure communication channels, such as the external communication channels 426 of FIG. 4 below. In order for the connection to succeed, it is crucial that these algorithms match for the QSL agent and KDC. To update these algorithms (i.e., to exercise cryptographic agility) while maintaining this crucial match, the disclosed system and methods can use the control plane tasking structure to trigger the cryptographic agility protocol as disclosed herein below, for example in FIGS. 5, 6A-6C, 7, and 8A. In particular, this cryptographic agility protocol may make use of a previously established secure channel (e.g., previously established AEAD symmetric keys) between the QSL agent and KDC to update the configured static, ephemeral, and client-side ciphersuite (e.g., KEM) for both the QSL agent and the KDC, as instructed (e.g., by an administrator via dashboard 202 or orchestrator 204). Note that the next public key (e.g., next_static_public_key in the example of FIG. 7 below) sent from the KDC to the QSL agent can embed the identity of its associated algorithm, such that the system may send both the static KEM algorithm and the public key in one payload.

FIG. 3 is a block diagram illustrating details 300 of service-to-service communications among nodes of an organizational network, such as between servers 208A and 208B of the network 200 of FIG. 2, according to an embodiment of the present disclosure. In some examples, the disclosed system and methods can provide post-quantum and zero-trust service-to-service communications 300 without the need for code changes.

In particular, the disclosed network (e.g., network 200 of FIG. 2) is a QSL solution that can transparently upgrade service-to-service communications 300 at layer 4 or layer 7 to post-quantum and zero-trust without any code changes required. The system can achieve this goal by providing a QSL node at the interface between each network application and the network itself, as shown in this example (e.g., QSL nodes 210A and 210B may be provided before servers 208A and 208B). In some examples, such as the example of FIG. 5 below, these QSL nodes may include proxies, which can belong to the control plane 252, and can enforce and implement cryptographic policy, e.g. from the management plane 254. For example, the proxies can apply a uniform layer of encryption, authentication, and authorization during service-to-service communication 300.

The system can additionally use the KDC and a Kerberos-based protocol to establish mutual authentication between the QSL nodes 210A and 210B (e.g., between proxies belonging to the QSL nodes 210A and 210B), and to securely distribute a high-entropy session secret. Each party (e.g., each of servers 208A and 208B and/or QSL nodes 210A and 210B) can then derive AEAD session keys from the session secret in order to encrypt subsequent communications.

In an example, the disclosed system may be based on a deployment model such as a service mesh or a plurality of client-side applications, which may be fronted with a reverse proxy. In effect, such a deployment model can extract security-related functionalities from applications, so application developers can focus efforts on developing applications, and need not be concerned with encrypting communications, configuring certificates, or managing keys. Accordingly, such a deployment model can provide advantages, such as orchestration, while avoiding some of the difficulties discussed above, such as fragmentation and poor visibility. In addition, using such a deployment model, the system 200 may support complex deployments of hundreds or thousands of disparate services, as in a cloud-native or microservices architecture, in addition to legacy or monolithic applications.

FIG. 4 is a block diagram illustrating an example network deployment 400 with cryptographically agile post-quantum cryptography, which provides an expedient interface for managing cryptographic policy at scale, according to an embodiment of the present disclosure.

In some cases, such as the ad-hoc approach in the example of FIG. 1, legacy cryptography ecosystems may face challenges or may be too decentralized or fragmented to support evolving algorithms, regulations, and policies at the needed scale. The disclosed system and methods can provide comprehensive approaches to cryptographic agility and policy, for example while migrating from legacy cryptography to current as well as future generations of post-quantum ciphersuites. FIG. 4 illustrates an example deployment of such a post-quantum, cryptographically agile solution encapsulated within the network 400. In some examples, the disclosed network deployment 400 can implement post-quantum cryptographic agility without the need for code changes.

In this example, the network deployment 400 includes an orchestrator 204, as in the example of FIG. 2, a data center 402, and a cloud platform 408. The data center 402 includes nodes 404A-404D (e.g., servers and/or clients), which may execute various business applications, such as a virtual machine, middleware, application service, or database. In this example, the nodes 404A-404C execute middleware, while node 404D executes a web app service. Note that these business applications can be co-located on the nodes 404A-404D, or can be separate. The nodes 404A-404D can include QSL nodes 406A-406D, as described in the examples of FIGS. 2-3 above and 5 below.

The example network deployment 400 can also include high-value back end systems 414, which can include QSL node 416, and database 418, which can include QSL node.

In an example, the cloud platform 408 can be connected to data center 402 via a cloud virtual private network (VPN) 407, such as a pre-quantum cloud VPN. The cloud platform 408 includes cloud virtual machine 410, which includes QSL node 412. The cloud virtual machine 410 may be in communication with clients 422A-C via the QSL node 412, and/or the nodes 404A-404D may be in communication with clients 422A-C via the QSL nodes 406A-406D.

In some examples, such as the example of FIG. 5 below, the QSL nodes 406A-D, 412, 416, and/or 420 may include proxies.

The network deployment 400 may include quantum-resilient channels of communication 428, which may be encapsulated within service-to-service communication channels 424 (e.g., via organizational network 200 and/or VPN 407) or external communication channels 426 (e.g., via the Internet). In some examples, the external communication channels 426 can include a QSL solution (for example, implemented by QSL node 412, by a proxy included in QSL node 412, and/or by client-side service workers and/or proxies) which can transparently upgrade web applications to post-quantum with no code changes or installations required on the part of clients 422A-C. In particular, from a cryptography perspective, the system may execute an ephemeral KEM exchange over HTTPS with a browser-based service worker, which proxies web application requests. As part of the protocol, the KDC can generate and distribute a high-entropy session secret to both the browser agent and the proxy (e.g., service worker). Each party can then derive AEAD (symmetric) session keys from the session secret for encrypting subsequent communications.

Likewise, as described further in the example of FIG. 3 above, the service-to-service communication channels 424 can upgrade service-to-service communications to post-quantum and zero-trust with no code changes required.

The example of FIG. 5 below further describes the management, control, and data planes, which may be included within some examples of post-quantum network deployment 400. The examples of FIGS. 5, 6A-6C, 7, and 8A-8C describe systems and methods for rapid, deterministic, centrally orchestrated cryptographic agility within networks such as organizational network 200 and post-quantum network deployment 400, which can improve administrative visibility and resist downgrade attacks.

FIG. 5 is a block diagram illustrating details of a system 500, including proxies, agents, and servers, for cryptography management and cryptographic agility, according to an embodiment of the present disclosure. For example, system 500 can implement cryptographic agility by swapping a ciphersuite, such as a key encapsulation mechanism (KEM) ciphersuite and/or an Authenticated Encryption with Associated Data (AEAD) ciphersuite.

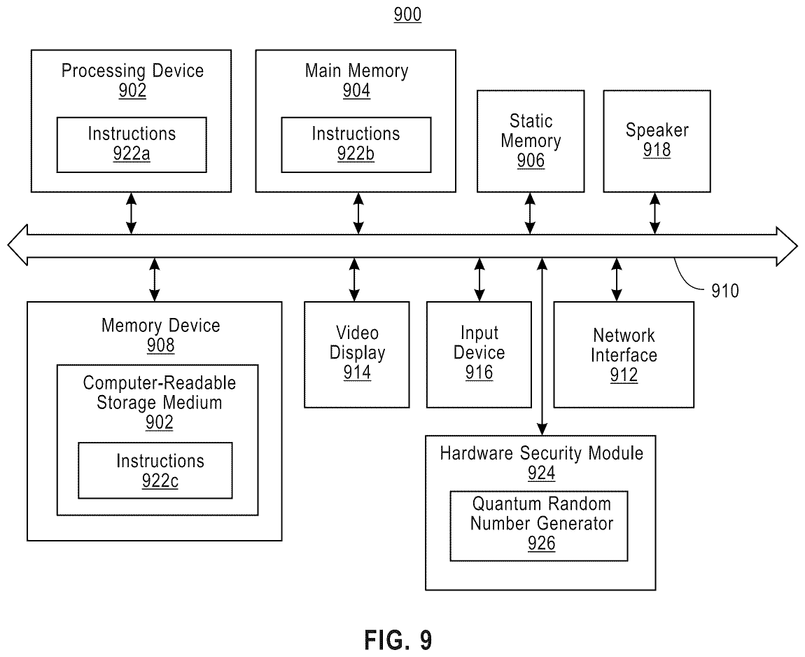

In this example, a cryptographic orchestration platform 502 communicates with servers, such as QSL nodes 210A and 210B. In various examples, the QSL agents 510A-510B can be implemented within a virtual process, bare metal computing nodes such as the example computer system 900 of FIG. 9 below, a container, and/or a virtual machine (VM).

The cryptographic orchestration platform 502 can include a configuration orchestrator 204 and a key distribution center (KDC) 512, which may also be referred to as a server (e.g., an orchestration server). In some examples, the KDC 512 may be a high-availability, scalable KDC that can support centralized generation of high-entropy keys. In particular, the KDC 512 can integrate with a quantum random number generator (QRNG), such as the QRNG 926 of FIG. 9, or bring-your-own-entropy via an API. This case may be particularly useful for Internet of Things (IoT) devices, which otherwise may lack a source of quality entropy.

Likewise, the QSL node 210A can include a proxy 507A, a configuration agent 508A, and a QSL agent 510A, and the QSL node 210B can include a proxy 507B, a configuration agent 508B, and a QSL agent 510B. In some examples, the configuration agents 508A-508B and/or QSL agents 510A-510B may be executable instructions (e.g., implemented in a language such as Go). In various examples, the proxies 507A-507B may include reverse and/or forward proxies. The QSL agents 510A-510B may maintain data structures for proxies 507A-507B, respectively (e.g., stored in a backing store), which may include the currently configured static KEM algorithm, the currently configured ephemeral KEM algorithm, and the static KEM public key of KDC 512.

In some examples, the proxies 507A-507B can be extensions of the Envoy proxy. The Envoy proxy is the basis for the cloud-native Istio service mesh, and the system may use a proxy with a similar deployment model, as described above in the example of FIG. 3. In general, the disclosed proxies 507A-507B may act as reverse proxies, which can upgrade any proxied application to post-quantum by integration with a QSL agent. The disclosed systems and methods, in combination with other systems and methods, can leverage the proxies 507A-507B to upgrade web applications and internal service communications to post-quantum without code changes. In some cases, the disclosed proxies 507A-507B can include a forward proxy in addition to, or as an alternative to, such a reverse proxy.

In some examples, QSL agents 510A-510B can be responsible for the QSL authentication, which can actually use ciphersuites (e.g., KEMs). That is, QSL agents 510A-510B can perform a post-quantum protocol on behalf of the proxy to establish a shared set of keys (e.g., symmetric AEAD keys) with the KDC 512. The cryptographic agility protocol, in turn, can use those previously established AEAD keys (e.g., an existing secure channel established by the shared AEAD keys) to securely transmit the changes for which ciphersuites (e.g., KEMs) are to be used in the subsequent execution of that post-quantum protocol.

The QSL agents 510A-510B may be lightweight agents which run on endpoints and execute PQNoise handshakes with the KDC 512. In particular, the end result of a PQNoise handshake is a post-quantum secure channel between QSL agents 510A-510B and KDC 512. Subsequent handshakes can establish forward-secure shared keys. At this point, the system can securely distribute KDC keys via QSL agents 510A-510B, meaning a number of options are available to integrate with other data plane components. The primary consumer is the proxy to support quantum-resilient communication channels, such as service-to-service communication channels 424 and external communication channels 426. However, only a QSL driver is needed to interface QSL agents 510A-510B with a different data plane solution. For example, QSL agents 510A-510B can be used to distribute KDC-generated pre-shared keys (PSKs) to upgrade a protocol at layer 3 or 4 (e.g., IPsec, WireGuard, or TLS 1.3) to post-quantum.

In some examples, each server can interact with business applications, such as the virtual machine, middleware, application service, or database of the example of FIG. 4. Note that these business applications can be co-located on the QSL agents 510A-510B, or be separate. In various examples, the QSL agents 510A-510B can be implemented within one or more of a virtual process, bare metal computing nodes, a container, or a virtual machine (VM).

In some examples, the KDC 512 can implement a QslServiceServer interface within a remote procedure call (RPC) framework, such as gRPC. Likewise, the configuration agents 508A-508B can implement a QslServiceServer interface, as well.

The various components of the system 500 can belong to a control plane 252 or data plane 250, as in the example of FIG. 2 above. In this example, the configuration orchestrator 204 and configuration agents 508A and 508B are part of the control plane 252, while the QSL agents 510A and 510B and KDC 512 are part of the data plane 250. In some examples, the planes can also include a management plane 254, as described in the example of FIG. 2.

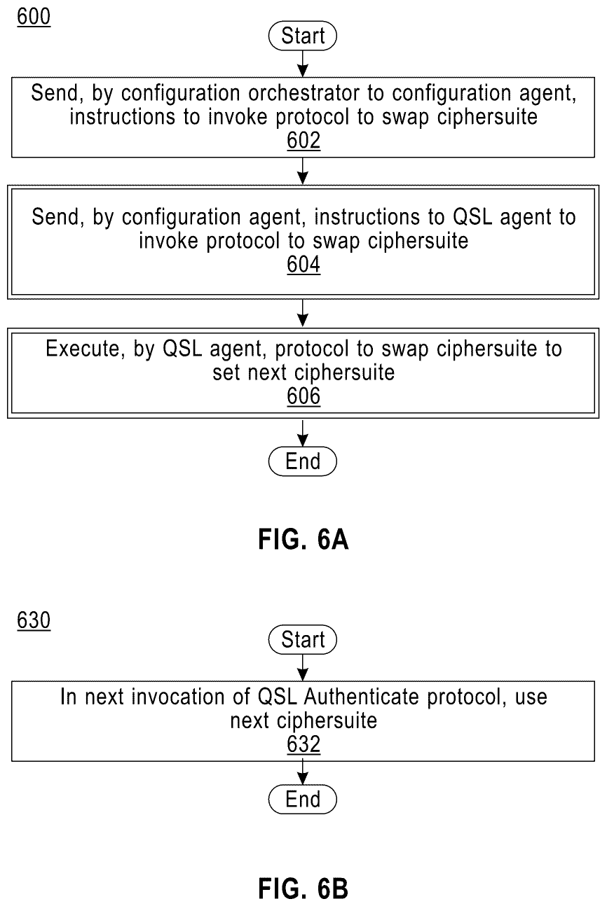

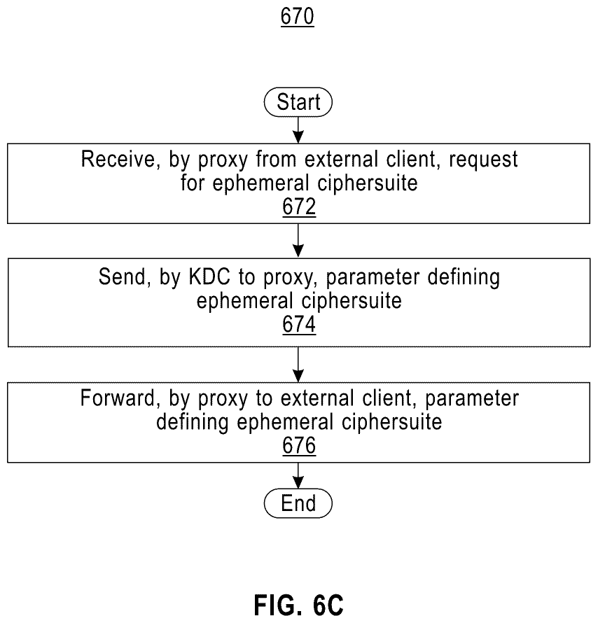

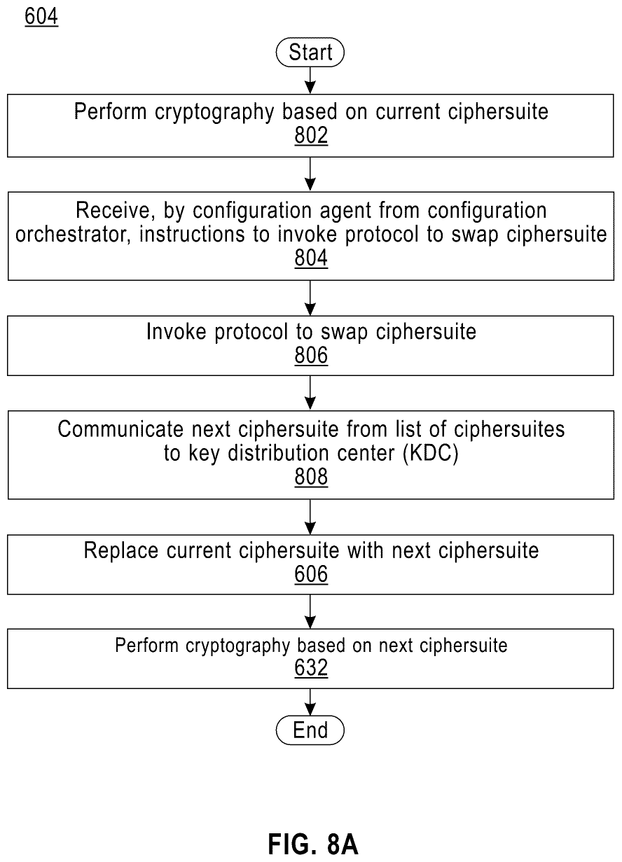

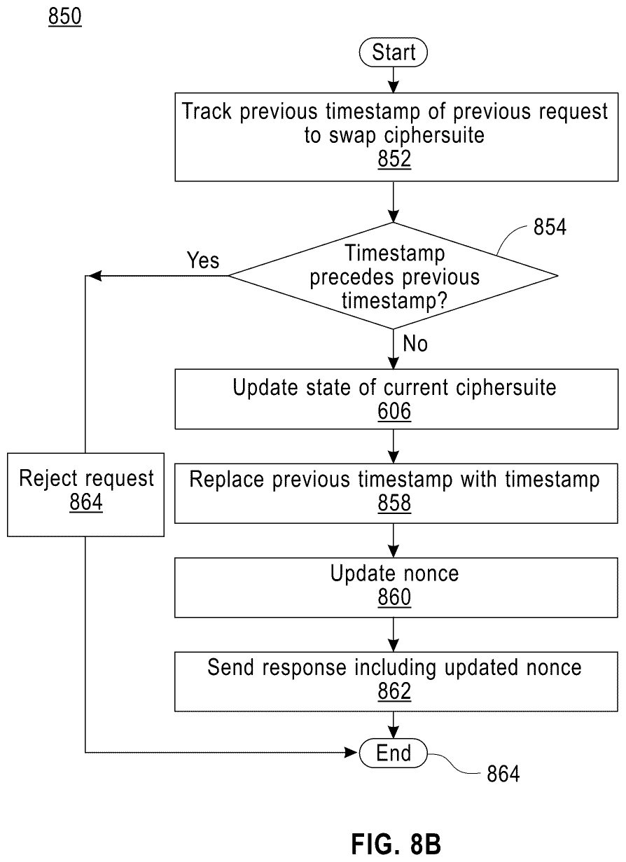

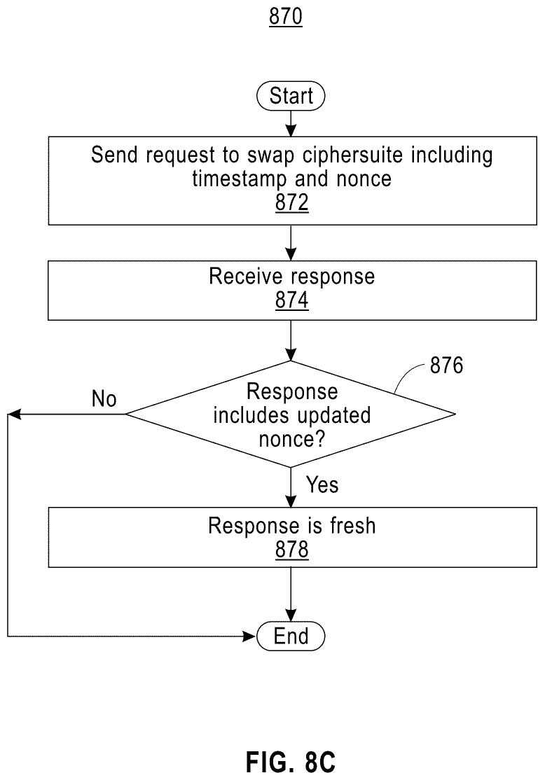

In some examples, a group 700 of essential components including the cryptographic orchestration platform 502, the configuration agents 508A-508B, and the QSL agents 510A-510B can participate in a protocol (e.g., a flow) to swap the ciphersuite, as in the example of FIG. 7 below. FIG. 6A is a flow diagram illustrating a method 600 of cryptographic agility by invoking a protocol to swap a ciphersuite, according to an embodiment of the present disclosure. The steps of the method 600 are also illustrated in the example of FIG. 5. For example, in operation 602, the configuration orchestrator 204 can instruct a respective one or more of configuration agents 508A-508B to invoke a protocol (e.g., a flow) to swap the current ciphersuite. In operation 604, the configuration agents 508A-508B can instruct the colocated QSL agents 510A-510B, respectively, to execute the protocol to swap the ciphersuite. For example, configuration agents 508A-508B can send 604 the instructions by making a local inter-process communication (IPC) call to QSL agents 510A-510B. Alternatively or additionally, configuration agents 508A-508B can send 604 the instructions over localhost, or send 604 the instructions between machines, send 604 the instructions over sockets, transfer the instructions in main memory, or otherwise call QSL agents 510A-510B. In some examples, invoking 604 and/or executing the protocol to swap the ciphersuite may include the respective configuration agents 508A-508B communicating the next ciphersuite from a listing to the respective QSL agents 510A-510B, and/or the respective QSL agents 510A-510B communicating the next ciphersuite to the KDC 512. Details of the protocol to swap the current ciphersuite are described below in the example of FIG. 8A.

In operation 606, the respective QSL agents 510A-510B and/or proxies 507A-507B can then execute the protocol to swap the ciphersuite, for example by replacing the current ciphersuite with the next ciphersuite. The protocol (e.g., flow) to swap the current ciphersuite, which may also be referred to as a ChangeClientAlgos protocol, is described in greater detail in the example of FIG. 7 below.

FIG. 6B is a flow diagram illustrating a method 630 of QSL authentication with cryptographic agility, according to an embodiment of the present disclosure. The steps of the method 630 are also illustrated in the example of FIG. 5. In operation 632, the next invocation of the QSL Authenticate protocol can utilize the next ciphersuite established by a previous execution 600 of the Change QSL Node Ciphersuite flow, as in the example of FIG. 6A. In some examples, the configuration agents 508A-508B and/or proxies 507A-507B can perform 632 cryptography based on the next ciphersuite. For example, performing 632 cryptography based on the next ciphersuite can involve performing a KEM key exchange operation according to an updated ciphersuite (e.g., an updated ephemeral KEM algorithm), for example after the ciphersuite is updated via the management plane by an administrator. In another example, the system can perform a QSL authentication handshake or an external client flow according to the next ciphersuite.

In some examples, performing 632 cryptography based on the next ciphersuite can include performing the cryptography based on the next ciphersuite during a plurality of sessions without renegotiating the next ciphersuite between sessions. For example, the ciphersuite can persist or be fixed across multiple sessions.

Alternatively or additionally, each of QSL nodes 210A-210B can interact with one or more external clients 514A-514B. For example, in some cases, the configuration agent 508A and/or 508B can invoke a protocol to swap an external client's ciphersuite, such as an external client's KEM algorithm or ephemeral KEM algorithm. In another example, proxy 507A and/or 507B can respond to an external client's request for a parameter defining a ciphersuite, such as an ephemeral KEM algorithm. FIG. 6C is a flow diagram illustrating a method 670 of configuring external clients for cryptographic agility, according to an embodiment of the present disclosure. Steps of the method 670 are also illustrated in the example of FIG. 5. For example, in operation 672, the proxy 507A and/or 507B can receive a request from an external client for an ephemeral KEM algorithm or another ciphersuite (e.g., if the next KEM algorithm is a next ephemeral KEM algorithm). In operation 674, the KDC 512 can send a parameter defining the current or updated ephemeral KEM algorithm or other ciphersuite to the proxy 507A and/or 507B. In step 676, the proxy 507A and/or 507B can forward the parameter to external clients 514A-514B. The external clients 514A-514B can then use the configured ciphersuite, e.g. a KEM. For example, the system can perform an external client flow according to an updated ciphersuite (e.g., an updated ephemeral KEM algorithm), for example after the ciphersuite is updated via the management plane by an administrator.

FIG. 7 is a communication flow diagram illustrating a protocol 700 to swap a ciphersuite, such as a KEM, according to an embodiment of the present disclosure. This protocol may also be referred to as a ChangeClientAlgos( ) protocol. The method 700 may be performed by a system including a configuration agent 508 or change-ciphersuite utility, a QSL agent 510, and a KDC 512. The QSL agent 510 may also be referred to as a client, and the KDC 512 may also be referred to as a server. In various examples, the protocol 700 can include a protocol to swap a ciphersuite associated with a server and/or an external client. Alternatively or additionally, in some examples, the protocol 700 may be performed by the configuration orchestrator, the control plane, or another tasking or control component.

In some examples, QSL agent 510 can be responsible for the QSL authentication, which can actually use ciphersuites. For example, the QSL authentication may make use of asymmetric algorithms such as KEMs that may be included in the ciphersuites. That is, QSL agent 510 can perform a post-quantum protocol on behalf of the proxy to establish a shared set of keys (e.g., symmetric AEAD keys) with the KDC 512. The cryptographic agility protocol 700, in turn, can use those previously established AEAD keys (e.g., an existing secure channel established by the shared AEAD keys) to securely transmit information about which ciphersuites (e.g., KEMs included in the ciphersuites) should be used in the subsequent post-quantum cryptographic operations.

In an example, the configuration agent 508 or change-ciphersuite utility first sends a message 604 to QSL agent 510 to invoke the protocol to swap a ciphersuite. In some examples, the configuration agent 508 or change-ciphersuite utility can send the message 604 via a local inter-process communication (IPC) call to a co-located QSL agent 510. Alternatively or additionally, the configuration agent 508 or change-ciphersuite utility can send the message 604 over localhost, over sockets, or otherwise call QSL agent 510.

In some examples, the message 604 can include (e.g., in a data structure) the QSL identifier (e.g., a unique identifier of a QSL node, also referred to as a QID) of the configuration agent 508 or change-ciphersuite utility (e.g., bytes id, as illustrated in FIG. 7) of configuration agent 508 and information identifying the next ciphersuite. For example, the information identifying the next ciphersuite may include a name of the next ciphersuite algorithm (e.g., a string), or any other identifier. In some cases, the configuration agents 508A-508B and/or proxies 507A-507B may already possess instructions to perform cryptography based on the next ciphersuite algorithm specified in the message 604. For example, such instructions may be encapsulated in a module. Accordingly, when the configuration agents 508A-508B and/or proxies 507A-507B receive the information identifying the next ciphersuite, they can subsequently perform cryptography based on the specified ciphersuite, as described in the example of FIG. 6B.

In some examples, the information identifying the next ciphersuite may include information identifying one or more next asymmetric algorithm, such as a next static KEM algorithm (e.g, string next_skem), a next ephemeral KEM algorithm (e.g., string next_ephem_kem), a next KEM algorithm (e.g., a next ephemeral KEM algorithm) used by an external client (e.g., string next_extern_kem), and/or a digital signature algorithm. In some examples, the information identifying the next ciphersuite may include more than one of these, for example, both a KEM and a digital signature algorithm. Alternatively or additionally, the next ciphersuite may include information identifying a next symmetric algorithm, such as a next Authenticated Encryption with Associated Data (AEAD) algorithm (e.g., string next_aead). Alternatively or additionally, the next ciphersuite may include information identifying a next cryptographic hash function (e.g., string next_hash), and/or a next cryptographic random number generator (e.g., string next_rng). In an example, these next ciphersuites can be chosen as the next element or elements from a list of ciphersuites. In another example, an administrator can choose the next ciphersuite or ciphersuites, for example via the dashboard view of management interface 202.

Next, if the next static KEM is present in the message 604 (e.g., if len (next_skem>0)), the QSL agent 510 can generate 704 a keypair (e.g., a static KEM keypair) corresponding to the next static KEM algorithm (e.g., by invoking KEM.KeyGen (kemAlgo)). For example, the generated keypair can include the client's next public key and private key. The QSL agent 510 may then distribute the generated public key (for example, as described in operation 706 below, by sending the public key to the KDC 512, which can then use the public key and/or redistribute the public key for use in encrypting messages). The QSL agent 510 may also use the private key to decrypt messages encrypted with the public key. Alternatively or additionally, the QSL agent may itself use the public key to encrypt messages, or send the public key to another keyserver for distribution.

Next, the QSL agent 510 can send a message 706 to KDC 512, which may also be referred to as a server (e.g., an orchestration server). The message 706 (e.g., a data structure) can include a binary QID identifier of the configuration agent 508 or change-ciphersuite utility (e.g., bytes id) for KDC 512, and an encrypted payload (e.g., bytes encrypted_payload). For example, QSL agent 510 can encrypt the payload using the existing shared set of keys (e.g., symmetric AEAD keys) between the QSL agent 510 and the KDC 512.

The encrypted payload can contain the client's next static public key, next ephemeral KEM algorithm (e.g., described by a string), the next external client's KEM algorithm (e.g., described by a string), next AEAD algorithm (e.g., described by a string), next cryptographic hash function (e.g., described by a string), next cryptographic random number generator (e.g., described by a string), next_skem, next_ekem, next_wkem, a timestamp, and a nonce. The timestamp and nonce details will be described in the examples of FIGS. 8B and 8C below.
where encrypted_payload=AEAD.Encrypt (proto.Marshal (
   bytes next_static_public_key;
   string next_ephem_kem;
   string next_extern_kem;
   string next_aead;
   string next_hash;
   string next_rng;
   uint64 timestamp;
   uint64 nonce;
))

For example, the next static public key in the payload of message 706 can be the public key generated by QSL agent 510 as part of the keypair in operation 704. This next static public key can be used for a handshake between QSL agent 510 and KDC 512, so as to exchange new AEAD keys and establish a new secure channel using the next AEAD algorithm. In some examples, the system utilizes hybrid cryptography, wherein the asymmetric cryptography (e.g., KEM) may be used exclusively for such a handshake so as to prepare the symmetric (e.g., AEAD) keys. Such hybrid cryptography may take advantage of the efficiency of symmetric cryptography, which can be orders of magnitude faster than asymmetric cryptography. At the same time, it can use asymmetric cryptography to encrypt and exchange the symmetric keys, thereby securely establishing a shared secret and providing forward secrecy. Note that message 706 can also include the algorithm associated with the next static public key (e.g., embedded with the next static public key), such that the payload can include both the static KEM algorithm and key simultaneously.

Next, the KDC 512 can send an encrypted response 708 (e.g., bytes encrypted_response) to QSL agent 510.

The encrypted response 708 can include the server's next static public key (e.g., bytes next_static_public_key), which can be generated by KDC 512 corresponding to the next ciphersuite. This next static public key can be used so that QSL agent 510 and KDC 512 can perform a handshake via asymmetric or public key cryptography, and subsequently exchange new symmetric (e.g., AEAD) keys and establish a new secure channel using the next symmetric algorithm. In some examples, the system utilizes hybrid cryptography, wherein the asymmetric cryptography (e.g., KEM) may be used exclusively for such a handshake so as to prepare the symmetric (e.g., AEAD) keys. Such hybrid cryptography may take advantage of the efficiency of symmetric cryptography, which can be orders of magnitude faster than asymmetric cryptography. At the same time, the hybrid cryptography can use asymmetric cryptography to encrypt and exchange the symmetric keys, thereby securely establishing a shared secret and providing forward secrecy. Accordingly, the cryptographic agility protocol 700 can perform an asymmetric cryptography handshake and exchange the corresponding public keys, in preparation to establish a new secure symmetric channel using the next symmetric algorithm.

Note also that the system can replace the existing symmetric cryptography channel, and rotate the symmetric (e.g., AEAD) keys before there is an appreciable risk of a collision of initialization vectors, which could lead to a catastrophic loss of security. For example, in the case of symmetric algorithms such as AES-GCM or ChaCha, the system can replace the existing channel and rotate the symmetric keys before they have been used to encrypt approximately 4 GB of data.

The encrypted response 708 can also include an updated nonce value (e.g., uint64 nonce). For example, the updated nonce can be incremented by one compared to the nonce from the request. The timestamp and nonce details will be described in the examples of FIGS. 8B and 8C below.

```
where encrypted_response = AEAD.Encrypt(proto.Marshal(
  bytes next_static_public_key,
  uint64 nonce; // nonce from request incremented by one
))
```

In some examples, the next symmetric (e.g., AEAD) keys may not be included in response 708, in order to preserve forward secrecy. For example, if an attacker were to compromise the symmetric (e.g., AEAD) keys for session n, the attacker could then eavesdrop on response 708 so as to obtain the symmetric keys for session n+1, and potentially repeat this process indefinitely into the future. By contrast, the use of public-key cryptography can “reset” trust, such that if an attacker succeeded in compromising the symmetric keys for session n, the attacker still could not compromise the symmetric keys for session n+1 without also possessing the corresponding asymmetric (e.g., KEM) private key, which is never transmitted.

Next, the QSL agent 510 (e.g., the client) and/or proxies can update 606 the local QSL Agent client data (e.g., QslAgent.ClientData), which can include replacing the current ciphersuite with the next ciphersuite. For example, the QSL Agent client data may include the client's QID with the server (e.g., described by bytes), a URL of the upstream KDC which the QSL agent is connecting to on behalf of the client (e.g., described by a string), current static public KEM key (e.g., described by bytes), current ephemeral KEM algorithm (e.g., described by a string), current ephemeral KEM algorithm used by external client (e.g., described by a string), next AEAD algorithm (e.g., described by a string), current AEAD encryption key (e.g., described by bytes), current AEAD decryption key (e.g., described by bytes), and the current cryptographic random number generator (e.g., described by a string). The client can update 606 this local information based on the received message 604.

Message QslAgent.ClientData{

| | |
|---|---|
| bytes id; | // client's QID with the server |
| string server_url; | // url of upstream KDC which qsl-agent is connecting to on |

behalf of this client

| | |
|---|---|
| bytes static_public_key; | //current static public KEM key |
| string ephemeral_kem; | // current ephemeral KEM algorithm |
| string external_kem; | // current ephemeral KEM algorithm used by |

external client

| | |
|---|---|
| string next_aead; | // next AEAD algorithm |
| bytes encryption_key; | // current AEAD encryption key |
| bytes decryption_key; | // current AEAD decryption key |
| string rng; | // current cryptographic random number generator |

}

Finally, the QSL agent 510 can send a status code 710 to the configuration agent 508 or change-ciphersuite utility. For example, the status code 710 can include an updated nonce and/or timestamp. Timestamp and nonce details will be described in the examples of FIGS. 8B and 8C below. In another example, the status code 710 can indicate whether the ciphersuite has been successfully swapped.

FIG. 8A is a flow diagram illustrating a method 800 of cryptographic agility by swapping a ciphersuite, according to an embodiment of the present disclosure. In various examples, the method 800 may be implemented by a configuration agent of a control plane (e.g., configuration agent 508 of FIGS. 5 and 7), a proxy of a data plane (e.g., proxy 507), a KDC (e.g., KDC 512), a quantum secure layer (QSL) agent, and/or a configuration orchestrator (e.g., orchestrator 204 of FIGS. 2 and 5). In various examples, the QSL agents 510A-510B can be implemented within a virtual process, bare metal computing nodes such as the example computer system 900 of FIG. 9 below, a container, and/or a virtual machine (VM), as in the example of FIG. 5. The proxy may include a reverse proxy or a forward proxy. In some cases, the proxy can communicate with business applications, a virtual machine, middleware, an application service, and/or a database, as in the examples of FIGS. 4 and 5.

In this example, the method 800 can start with the configuration agent performing 802 cryptography based on a current ciphersuite. Alternatively or additionally, in some examples, the cryptography based on the current ciphersuite can be performed 802 by the proxy. The current ciphersuite can include one or more current asymmetric algorithm (for example, a current KEM algorithm and/or a current digital signature algorithm), a current symmetric algorithm (e.g., a current AEAD algorithm), a current cryptographic random number generator, or a current cryptographic hash function.

The method can further include the configuration agent receiving 804, from the configuration orchestrator, instructions to invoke a protocol to swap the current ciphersuite. For example, the instructions can be a response to input received by the configuration orchestrator, such as when an administrator sets a new ciphersuite via the dashboard or a user interface. Alternatively or additionally, the configuration orchestrator can receive instructions from a configuration management platform, or an automation platform.

The method can further include the configuration agent invoking 806, responsive to receiving the instructions, the protocol to swap the current ciphersuite. For example, the configuration agent can make an IPC call to the QSL agent to execute the protocol, as in the examples of FIGS. 6A and 7.

The method can further include the QSL agent communicating 808 a next ciphersuite from a set of ciphersuites to the KDC. In one example, the next ciphersuite may be a next item from an ordered list or ordered set of ciphersuites. Alternatively or additionally, the next ciphersuite may correspond to a selection of an administrator, for example an administrator may specify the next ciphersuite via the management plane, the management interface or dashboard, and/or a user interface of the orchestrator. In yet another example, the configuration orchestrator may receive instructions regarding the next ciphersuite from a configuration management platform or automation platform. In some examples, the QSL agent may receive the next ciphersuite from the configuration agent. Alternatively or additionally, the next ciphersuite may be specified in the instructions received from the configuration orchestrator to invoke the protocol to swap the ciphersuite.

The next ciphersuite can include one or more next asymmetric algorithm (e.g., a next KEM algorithm and/or a next digital signature algorithm), one or more next symmetric algorithm (e.g., a next AEAD algorithm), one or more next cryptographic random number generator, or one or more next cryptographic hash function. In some examples, the next KEM algorithm can include a next static KEM algorithm to be used in a QSL authentication handshake, a next ephemeral KEM algorithm to be used in a QSL authentication handshake, and/or a next ephemeral KEM algorithm to be used in an external client flow.

For example, the next ciphersuite can include a Bit flipping Key Encapsulation Mechanism (BIKE) algorithm, a CRYSTALS Kyber algorithm, a Classic McEliece algorithm, a Hamming Quasi Cyclic (HQC) algorithm, a National Institute of Standards and Technology (NIST) candidate post-quantum algorithm, an Enhanced McEliece algorithm, a Random Linear Code Encryption Scheme (RLCE) algorithm, another next post-quantum algorithm, a hash deterministic random bit generator (Hash_DRBG), a hash-based message authentication code (HMAC_DRBG), another cryptographic random number generator, a SHA256 algorithm, or an AES256-GCM algorithm. Alternatively or additionally, the next ciphersuite can include any other ciphersuite, and is not limited by the present disclosure.

The method can further include replacing 606 the current ciphersuite with the next ciphersuite. In some examples, replacing 606 the current ciphersuite can involve the QSL agent updating the ciphersuite based on the next ciphersuite. In some examples, replacing 606 the current ciphersuite can involve the QSL agent generating a static KEM keypair, as in the example of FIG. 7 above. Replacing 606 the current ciphersuite with the next ciphersuite is further described above in the examples of FIGS. 6A and 7.

The method can further include the configuration agent or the proxy performing 632 cryptography based on the next ciphersuite. Alternatively or additionally, in some examples, the cryptography based on the current ciphersuite can be performed 632 by the proxy. For example, performing 632 cryptography based on the next ciphersuite can involve performing a KEM key exchange operation, a QSL authentication handshake, or an external client flow according to the next ciphersuite. Performing 632 cryptography based on the next ciphersuite is further described above in the example of FIG. 6B.

The method 800 may then end.

FIG. 8B is a flow diagram illustrating timestamp and nonce details of a method 850 of cryptographic agility by swapping a ciphersuite, according to an embodiment of the present disclosure. In some examples, the method 850 may be implemented by a server, such as by the KDC 512 of FIG. 5.

In this example, the method 850 can start with the server (e.g., KDC 512) tracking 852 a previous timestamp of a previous request from the configuration agent to swap the ciphersuite. For example, as described in the examples of FIG. 7 above and FIG. 8C below, when the server (e.g., KDC 512) receives a respective request from a client (e.g., the message 706 from QSL agent 510) to swap the ciphersuite, the respective request can include a timestamp and a nonce (e.g., having a random or pseudorandom value). Accordingly, the server (e.g., the KDC) can track 852 a previous timestamp of a previous request from the same client (e.g., the same QSL agent). For example, the server can track 852 within a ClientData entry the timestamp of the last ChangeClientAlgos request for that client, e.g. the last time the server executed this flow.

In particular, in some examples, the server (e.g., KDC) may have a backing store which maps a QSL ID (e.g., an identifier of the QSL agent sending the request) to a ClientData structure for each registered QSL client. For example, as described above in the examples of FIGS. 5, 6A, and 8A, the ClientData entry may contain the currently configured static KEM algorithm, the currently configured ephemeral KEM algorithm, the QSL Agent's static KEM public key, and the currently configured client-side KEM algorithm for the associated proxies (e.g., proxy 507A and/or 507B), in addition to other objects.

The method can then continue with the server comparing 854 the timestamp included in the current request with the tracked previous timestamp, in order to determine whether the received timestamp precedes the previous timestamp of the previous request.

Responsive to the received request having a timestamp that precedes the last seen timestamp, the method can further include the server rejecting 864 the received request. For example, the server can return an error message, such as an old request error, to the client. The method 850 can then end.

Responsive to the received timestamp included in the current request not preceding the tracked previous timestamp, the method can further include updating 606 the state of the current ciphersuite, for example within a backing store or local data structure such as the ClientData structure. Accordingly, if the received timestamp does not precede the previous timestamp, the server can continue to update 606 the state of the current ciphersuite (e.g., within the ClientData structure), and, upon success, can update the server's representation of the last seen timestamp. Updating 606 the state of the current ciphersuite is described further in the examples of FIGS. 6A, 7, and 8A above.

The method can further include the server replacing 858 the previous timestamp with the timestamp of the received request. For example, the server can begin to track 858 the timestamp of the current received request, for example the server can track 858 the timestamp received with the ChangeClientAlgos request within a ClientData entry for the client.

The method can further include the server updating 860 the nonce value. In some examples, updating 860 the nonce can comprise incrementing the nonce (e.g., the updated nonce value can be an incremented value of the original nonce+1). Alternatively, the nonce may be updated 860 in any other way, and is not limited by the present disclosure.

The method can further include the server sending 862 a response (e.g., ChangeClientAlgosResponse) including the updated nonce value, so as to prove freshness of the response and prevent replay attacks. The response may be encrypted, and may also include the server's next public key and/or other objects, as described in the example of FIG. 7.

The method 850 may then end.

FIG. 8C is a flow diagram illustrating timestamp and nonce details of a method 870 of cryptographic agility by swapping a ciphersuite, according to an embodiment of the present disclosure. In some examples, the method 870 may be implemented by a client, such as by the QSL agent 510 of FIG. 5.

In this example, the method 870 can start with the client (e.g., QSL agent 510) sending 872 a request to swap the current ciphersuite to a server (e.g., the KDC 512 of FIG. 5). In some examples, the client can include a timestamp with each request to swap the current ciphersuite that it sends 872 to the server (e.g., KDC 512). The client can also include a nonce value (e.g., a pseudorandom or random nonce) with each request to swap the current ciphersuite. For example, as described in FIG. 7 above, QSL agent 510 can send a message 706 to KDC 512, which contains a timestamp and nonce.

The method can further include the client receiving 874 a response (e.g., ChangeClientAlgosResponse) from the server (e.g., KDC 512), which can include a nonce value.

The method can further include the client confirming 876 that the nonce value included in the response is updated. In an example, the received nonce may be incremented to the original nonce value plus one. Alternatively, the nonce may be updated in any other way, and is not limited by the present disclosure.

Responsive to the nonce value not being updated, or not matching an expected updated value, the client may then reject or ignore the received response, and proceed to end the method 870. Reject or ignoring a stale response may help to prevent replay attacks.

Responsive to the nonce value being updated, the method can further include the client determining 878 that the response is fresh. Determining 878 that the response is fresh may help to safeguard against replay attacks.

The method 870 may then end.

FIG. 9 is a block diagram of an example computer system 900 which can perform any one or more of the methods described herein, in accordance with one or more aspects of the present disclosure. In one example, the computer system 900 may include a computing device and may correspond to one or more of the servers 102, orchestrator 204, management interface 202, servers 208, QSL nodes 210, nodes 404, virtual machines 410, clients 422, back-end systems 414, KDC 512, or any suitable component of FIGS. 1-5. Note that, in various examples, various components of FIGS. 1-5 can be implemented within bare metal computing nodes such as example computer system 900, a virtual process, a container, and/or a virtual machine (VM).

The computer system 900 may be connected (e.g., networked) to other computer systems in a local area network (LAN), an intranet, an extranet, or the Internet, including via the cloud or a peer-to-peer network. The computer system 900 may operate in the capacity of a server in a client-server network environment. The computer system 900 may be a personal computer (PC), a tablet computer, a wearable (e.g., wristband), a set-top box (STB), a personal Digital Assistant (PDA), a mobile phone, a smartphone, a camera, a video camera, an Internet of Things (IoT) device, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 900 (one example of a “computing device”) illustrated in FIG. 9 includes a processing device 902, a main memory 904 (e.g., read-only memory (ROM), flash memory, solid state drives (SSDs), dynamic random-access memory (DRAM) such as synchronous DRAM (SDRAM)), a static memory 906 (e.g., flash memory, solid state drives (SSDs), or static random-access memory (SRAM)), and a memory device 908, wherein any of the foregoing may communicate with each other via a bus 910. In some implementations, the computer system 900 may further include a hardware security module 924.

The processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a system on a chip, a field programmable gate array (FPGA), a digital signal processor (DSP), network processor, or the like. The processing device 902 may be configured to execute instructions for performing any of the operations and steps discussed herein.

The computer system 900 illustrated in FIG. 9 further includes a network interface device 912. The computer system 900 also may include a video display 914 (e.g., a liquid crystal display (LCD), a light-emitting diode (LED), an organic light-emitting diode (OLED), a quantum LED, a cathode ray tube (CRT), a shadow mask CRT, an aperture grille CRT, or a monochrome CRT), one or more input devices 916 (e.g., a keyboard and/or a mouse or a gaming-like control), and one or more speakers 918 (e.g., a speaker). In one illustrative example, the video display 914 and the one or more input devices 916 may be combined into a single component or device (e.g., an LCD touchscreen).

The memory device 908 may include a computer-readable storage medium 902 on which the instructions 922c embodying any one or more of the methods, operations, or functions described herein are stored. The instructions 922c may also reside, completely or at least partially, within the main memory 904 as instructions 922b and/or within the processing device 902 during execution thereof by the computer system 900. As such, the main memory 904 or as instruction 922a and the processing device 902 also constitute computer-readable media. The instructions 922 may further be transmitted or received over a network via the network interface device 912.

While the computer-readable storage medium 920 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium capable of storing, encoding or carrying out a set of instructions for execution by the machine and that cause the machine to perform any one or more of the methods disclosed herein. The term “computer-readable storage medium” shall accordingly be taken to include, but not be limited to, solid-state memories, optical media, and magnetic media.

While the computer system environment of 900 shows the basic components the addition of a Hardware Security Module 924 associated with a Quantum Random Number Generator 926 are added to complete the entropy required for Post Quantum computations and interactions. The use of these components is critical as described previously in the overall methods used for this system.

No part of the description in this application should be read as implying that any particular element, step, or function is an essential element that must be included in the claim scope. The scope of patented subject matter is defined only by the claims. Moreover, none of the claims is intended to invoke 25 U.S.C. § 104(f) unless the exact words “means for” are followed by a participle.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Once the above disclosure is fully appreciated, numerous variations and modifications will become apparent to those skilled in the art. It is intended that the following claims be interpreted to embrace all such variations and modifications.

1. A method to swap a ciphersuite, comprising:
performing, by a configuration agent of a control plane or a proxy of a data plane, cryptography based on a current ciphersuite, wherein the current ciphersuite comprises a current asymmetric algorithm, a current symmetric algorithm, a current cryptographic random number generator, or a current cryptographic hash function;
receiving, by the configuration agent and from a configuration orchestrator, instructions to invoke a protocol to swap the current ciphersuite;
invoking, by the configuration agent and responsive to receiving the instructions, the protocol to swap the current ciphersuite;
communicating, by a quantum secure layer (QSL) agent, a next ciphersuite from a set of ciphersuites to a key distribution center (KDC), wherein the next ciphersuite comprises a next asymmetric algorithm, a next symmetric algorithm, a next cryptographic random number generator, or a next cryptographic hash function;
replacing the current ciphersuite with the next ciphersuite; and
performing, by the configuration agent or the proxy, cryptography based on the next ciphersuite.

2. The method of claim 1, wherein the next ciphersuite includes at least one of, but is not limited to:
Bit flipping Key Encapsulation Mechanism (BIKE);
CRYSTALS Kyber;
Classic McEliece;
Hamming Quasi Cyclic (HQC);
a National Institute of Standards and Technology (NIST) candidate post-quantum algorithm;
another next post-quantum ciphersuite;
SHA256; or
AES256-GCM.

3. The method of claim 1, wherein performing the cryptography based on the next ciphersuite comprises performing at least one Key Encapsulation Mechanism (KEM) key exchange operation according to the next ciphersuite.

4. The method of claim 1, further comprising performing a QSL authentication handshake or an external client flow according to the next ciphersuite.

5. The method of claim 1, further comprising communicating, by the configuration agent and to the QSL agent, the next ciphersuite.

6. The method of claim 1, wherein replacing the current ciphersuite with the next ciphersuite comprises updating, by the QSL agent, the ciphersuite based on the next ciphersuite.

7. The method of claim 1, wherein the next ciphersuite comprises the next asymmetric algorithm, and wherein the next asymmetric algorithm comprises a next Key Encapsulation Mechanism (KEM) algorithm.

8. The method of claim 7, wherein the next KEM algorithm comprises at least one of:
a next static KEM algorithm to be used in a QSL authentication handshake;
a next ephemeral KEM algorithm to be used in a QSL authentication handshake; or
a next ephemeral KEM algorithm to be used in an external client flow.

9. The method of claim 7:
wherein:
the next KEM algorithm comprises an ephemeral KEM algorithm; and
the cryptography based on the next ciphersuite is performed by the proxy of the data plane; and
further comprising:
receiving, by the proxy and from an external client, a request for the ephemeral KEM algorithm;
receiving, by the proxy and from the KDC, a parameter defining the ephemeral KEM algorithm; and
forwarding, by the proxy and to the external client, the parameter.

10. The method of claim 1, wherein the next ciphersuite comprises the next symmetric algorithm, and wherein the next symmetric algorithm comprises a next Authenticated Encryption with Associated Data (AEAD) algorithm.

11. The method of claim 1, wherein the next ciphersuite comprises the next cryptographic random number generator.

12. The method of claim 1, wherein the next ciphersuite comprises the next cryptographic hash function.

13. The method of claim 1, wherein the protocol to swap the ciphersuite is performed by at least one of:
the configuration agent;
the configuration orchestrator;
the control plane;
a QSL agent;
the KDC; or
another tasking or control component.

14. The method of claim 1:
wherein invoking the protocol to swap the ciphersuite comprises sending, by a QSL agent and to the KDC, a timestamp and a random nonce; and
further comprising:
tracking, by the KDC, a previous timestamp of a previous request of the configuration agent to swap the ciphersuite;
responsive to the timestamp not preceding the previous timestamp:
performing the protocol to swap the ciphersuite; and
replacing the previous timestamp with the timestamp;
updating the nonce; and
sending a response including the updated nonce.

15. The method of claim 14, wherein updating the nonce comprises incrementing the nonce.

16. The method of claim 1, wherein the protocol to swap the ciphersuite comprises a protocol to swap a server ciphersuite or a protocol to swap an external client ciphersuite.

17. The method of claim 1, further comprising receiving, by the configuration orchestrator, instructions from a user interface, a dashboard, a configuration management platform, or an automation platform.

18. The method of claim 1, wherein the cryptography based on the next ciphersuite is performed by the proxy of the data plane, and wherein the proxy comprises a reverse proxy or a forward proxy.

19. The method of claim 1, wherein the cryptography based on the next ciphersuite is performed by the proxy of the data plane, and wherein the proxy communicates with at least one of:
a virtual machine;
middleware;
an application service; or
a database.

20. The method of claim 1, wherein replacing the current ciphersuite with the next ciphersuite comprises generating, by the QSL agent, a static Key Encapsulation Mechanism (KEM) keypair.

21. A computing system configured to swap a ciphersuite, the computing system comprising:
a memory; and
at least one processor coupled to the memory and configured to:
perform, via a configuration agent of a control plane or a proxy of a data plane, cryptography based on a current ciphersuite, wherein the current ciphersuite comprises a current asymmetric algorithm, a current symmetric algorithm, a current cryptographic random number generator, or a current cryptographic hash function;
receive, by the configuration agent and from a configuration orchestrator, instructions to invoke a protocol to swap the current ciphersuite;
invoke, via the configuration agent and responsive to receiving the instructions, the protocol to swap the current ciphersuite;
communicate, via a quantum secure layer (QSL) agent, a next ciphersuite algorithm from a set of ciphersuites to a key distribution center (KDC), wherein the next ciphersuite comprises a next asymmetric algorithm, a next symmetric algorithm, a next cryptographic random number generator, or a next cryptographic hash function;
replace the current ciphersuite with the next ciphersuite; and
perform, by the configuration agent or the proxy, cryptography based on the next ciphersuite.

22. The computing system of claim 21, wherein the next ciphersuite includes at least one of, but is not limited to:
Bit flipping Key Encapsulation Mechanism (BIKE);
CRYSTALS Kyber;
Classic McEliece;
Hamming Quasi Cyclic (HQC);
a National Institute of Standards and Technology (NIST) candidate post-quantum algorithm;
another next post-quantum ciphersuite;
SHA256; or
AES256-GCM.

23. The computing system of claim 21, wherein to perform the cryptography based on the next ciphersuite comprises to perform at least one KEM key exchange operation according to the next ciphersuite.

24. The computing system of claim 21, wherein the processor is further configured to communicate, via the configuration agent and to the QSL agent, the next ciphersuite.

25. The computing system of claim 21, wherein the processor is further configured to perform a QSL authentication handshake or an external client flow according to the next ciphersuite.

26. The computing system of claim 21, wherein the next ciphersuite comprises the next asymmetric algorithm, and wherein the next asymmetric algorithm comprises a next Key Encapsulation Mechanism (KEM) algorithm.

27. The computing system of claim 26, wherein the next KEM algorithm comprises at least one of:
a next static KEM algorithm to be used in a QSL authentication handshake;
a next ephemeral KEM algorithm to be used in a QSL authentication handshake; or
a next ephemeral KEM algorithm to be used in an external client flow.

28. The computing system of claim 26:
wherein the next KEM algorithm comprises an ephemeral KEM algorithm; and
wherein the processor is further configured to:
receive, via the proxy and from an external client, a request for the ephemeral KEM algorithm;
receive, via the proxy and from the KDC, a parameter defining the ephemeral KEM algorithm; and
forward, via the proxy and to the external client, the parameter.

29. The computing system of claim 21, wherein the next ciphersuite comprises the next symmetric algorithm, and wherein the next symmetric algorithm comprises a next Authenticated Encryption with Associated Data (AEAD) algorithm.

30. The computing system of claim 21, wherein the next ciphersuite comprises the next cryptographic random number generator.

31. The computing system of claim 21, wherein the next ciphersuite comprises the next cryptographic hash function.

32. The computing system of claim 21, wherein the protocol to swap the ciphersuite comprises a protocol to swap a server ciphersuite or a protocol to swap an external client ciphersuite.

33. The computing system of claim 21, wherein the proxy comprises a reverse proxy or a forward proxy.

34. The computing system of claim 21, wherein the processor is further configured to communicate, via the proxy, with at least one of:
a virtual machine;
middleware;
an application service; or
a database.

35. The computing system of claim 21, wherein to replace the current ciphersuite with the next ciphersuite comprises to generate, via the QSL agent, a static Key Encapsulation Mechanism (KEM) keypair.

36. A non-transitory computer readable medium storing executable sequences of instructions to:
perform, via a configuration agent of a control plane or a proxy of a data plane, cryptography based on a current ciphersuite, wherein the current ciphersuite comprises a current asymmetric algorithm, a current symmetric algorithm, a current cryptographic random number generator, or a current cryptographic hash function;
receive, by the configuration agent and from a configuration orchestrator, instructions to invoke a protocol to swap the current ciphersuite;
invoke, via the configuration agent and responsive to receiving the instructions, the protocol to swap the current ciphersuite;
communicate, via a quantum secure layer (QSL) agent, a next ciphersuite from a set of ciphersuites to a key distribution center (KDC), wherein the next ciphersuite comprises a next asymmetric algorithm, a next symmetric algorithm, a next cryptographic random number generator, or a next cryptographic hash function;
replace the current ciphersuite with the next ciphersuite; and
perform, by the configuration agent or the proxy, cryptography based on the next ciphersuite.

37. The non-transitory computer readable medium of claim 36, wherein the next ciphersuite includes at least one of, but is not limited to:
Bit flipping Key Encapsulation Mechanism (BIKE);
CRYSTALS Kyber;
Classic McEliece;
Hamming Quasi Cyclic (HQC);
a National Institute of Standards and Technology (NIST) candidate post-quantum algorithm;
another next post-quantum ciphersuite;
SHA256; or
AES256-GCM.

38. The non-transitory computer readable medium of claim 36, wherein to perform the cryptography based on the next ciphersuite comprises to perform at least one KEM key exchange operation according to the next ciphersuite.

39. The non-transitory computer readable medium of claim 36, wherein the executable sequences of instructions further comprise instructions to perform a QSL authentication handshake or an external client flow according to the next ciphersuite.

40. The non-transitory computer readable medium of claim 36, wherein the next ciphersuite comprises the next asymmetric algorithm, and wherein the next asymmetric algorithm comprises a next Key Encapsulation Mechanism (KEM) algorithm.

41. The non-transitory computer readable medium of claim 40, wherein the next KEM algorithm comprises at least one of:
a next static KEM algorithm to be used in a QSL authentication handshake;
a next ephemeral KEM algorithm to be used in a QSL authentication handshake; or
a next ephemeral KEM algorithm to be used in an external client flow.

42. The non-transitory computer readable medium of claim 40, wherein:
the next KEM algorithm comprises an ephemeral KEM algorithm; and
the executable sequences of instructions further comprise instructions to:
receive, via the proxy and from an external client, a request for the ephemeral KEM algorithm;
receive, via the proxy and from the KDC, a parameter defining the ephemeral KEM algorithm; and
forward, via the proxy and to the external client, the parameter.

43. The non-transitory computer readable medium of claim 36, wherein the next ciphersuite comprises the next symmetric algorithm, and wherein the next symmetric algorithm comprises a next Authenticated Encryption with Associated Data (AEAD) algorithm.

44. The non-transitory computer readable medium of claim 36, wherein the protocol to swap the ciphersuite comprises a protocol to swap a server ciphersuite or a protocol to swap an external client ciphersuite.

45. The non-transitory computer readable medium of claim 36, wherein the executable sequences of instructions further comprise instructions to communicate, via the proxy, with at least one of:
a virtual machine;
middleware;
an application service; or
a database.
